(19) United States
(12) Patent Application Publication
(10) Pub. No.: US 2014/0158921 A1
(43) Pub. Date: Jun. 12, 2014

(54) ELECTROMAGNETIC VALVE DEVICE FOR HIGH-PRESSURE FLUID

(71) Applicant: DENSO CORPORATION, Kariya-city (JP)

(72) Inventors: Ryo ISHIBASHI, Anjo-city (JP); Akira Takagi, Obu-city (JP)

(73) Assignee: DENSO CORPORATION, Kariya-city (JP)

(21) Appl. No.: 14/090,447

(22) Filed: Nov. 26, 2013

(30) Foreign Application Priority Data
Nov. 27, 2012 (JP) 2012-258243

(51) Int. Cl. F16K 31/02

(52) U.S. Cl. CPC F16K 31/02
USPC 251/129.09

(57) ABSTRACT

A guide portion slidably receiving a movable core is constructed by a medium-diameter portion, a first small-diameter portion, and a second small-diameter portion. A magnetism blocking portion is provided between the first small-diameter portion and the second small-diameter portion. A ring portion is provided at a periphery of the medium-diameter portion, and abuts on a yoke. When a coil is energized, a magnetic circuit is generated to pass through the yoke, the medium-diameter portion, the first small-diameter portion, the movable core, and the second small-diameter portion, and to bypass the magnetism blocking portion. In addition, another magnetic circuit passing through the ring portion is also generated. A magnetic attractive force inclining with a center axis of the guide portion is generated between the second small-diameter portion and an end surface according to an expansion magnetic circuit, and the movable core is moved towards the stator core.

### CROSS-REFERENCE TO RELATED APPLICATION

This application is based on Japanese Patent Application No. 2012-258243 filed on Nov. 27, 2012, the disclosure of which is incorporated herein by reference.

### TECHNICAL FIELD

The present disclosure relates to an electromagnetic valve device for a high-pressure fluid, which blocks or allows a flow of the high-pressure fluid by using an electromagnetic valve.

### BACKGROUND

It is known that a gaseous fuel supplying system depressurizes a pressure of a gaseous fuel supplied to an internal combustion engine from a high-pressure in a fuel tank to a low-pressure so that an injector for the gaseous fuel is capable of injecting the gaseous fuel. Hereafter, the internal combustion engine is referred to as an engine. An electromagnetic valve device for the gaseous fuel is provided in the gaseous fuel supplying system. The electromagnetic valve device for the gaseous fuel includes a valve driving portion and a valve member portion. The valve driving portion is constructed by a coil which generates magnetic force by energization, a stator core, a movable core, and a guide portion which slidably receives the movable core. The valve member is constructed by a valve member moving integrally with the movable core, and a valve seat. The electromagnetic valve device for the gaseous fuel cuts off a flow of the gaseous fuel of high-pressure to prevent the gaseous fuel of high-pressure from flowing into the injector for the gaseous fuel.

The electromagnetic valve device for the gaseous fuel has a self-seal function which improves an air tightness between the valve member and the valve seat by using the pressure of the gaseous fuel supplied by the fuel tank. Therefore, the guide portion of the electromagnetic valve device for the gaseous fuel is filled with the gaseous fuel of high-pressure so that the valve member is biased in a valve closing direction. Further, the guide portion has a pressure resistant to prevent a leak of the gaseous fuel.

When the valve member separates from the valve seat, a magnetic attractive force repelling the pressure of the gaseous fuel in the guide portion is generated between the movable core and the stator core. Therefore, a diameter of the movable core is relatively increased.

In the electromagnetic valve device for the gaseous fuel, since the guide portion slidably receives the movable core having a large-diameter and has to have a pressure resistant, the guide portion has a wall thickness thicker than that of the guide portion in which the high-pressure fluid is not fully filled. Generally, when a wall thickness of a guide portion made of a non-magnetic material becomes thicker, the magnetic attractive force generated relative to a value of a current flowing through the coil becomes smaller. To increase the magnetic attractive force between the movable core and the stator core, the current may be increased, or a number of reels of the coil may be increased. However, when the current is increased, an energy consumption amount is increased. When the number of reels of the coil is increased, a size of the electromagnetic valve device becomes larger.

Japanese Patent No. 4871207 discloses a high-pressure electromagnetic valve having a magnetic field auxiliary member provided on a part of a guide portion radially outside of the guide portion. Further, the magnetic field auxiliary member is made of a magnetic material, and the guide portion is made of a non-magnetic material. JP-2011-108781A discloses a linear solenoid having a magnetism blocking portion for transferring magnetism from a space between the linear solenoid and a plunger to a stator core. Further, the stator core is made of a magnetic material and slidably receives the plunger.

However, in the high-pressure electromagnetic valve disclosed in Japanese Patent No. 4871207, since the guide portion is made of a non-magnetic material, the magnetic attractive force generated relative to the value of the current flowing through the coil cannot be increased large enough. Therefore, the size of the electromagnetic valve device becomes larger. Further, since the magnetic field auxiliary member is provided as another part, a number of parts is increased. Therefore, a cost of attachment is increased.

Since the linear solenoid disclosed in JP-2011-108781A is used to switch a flow of an operating fluid of relatively low-pressure at an operating pressure range, a leakage of oil as the operating fluid is allowed, and the linear solenoid has no self-seal function. Therefore, the linear solenoid disclosed in JP-2011-108781A cannot be used in the electromagnetic valve device for the high-pressure fluid.

### SUMMARY

It is an object of the present disclosure to provide an electromagnetic valve device for a high-pressure fluid, in which a flow of the high-pressure fluid is blocked or allowed, and the electromagnetic valve device can be miniaturized.

According to an aspect of the present disclosure, an electromagnetic valve device for a high-pressure fluid includes a coil assembly, a stator core, a movable core, a guide portion, a ring portion, and a cover portion. The coil assembly generates a magnetic force when being energized. The stator core is made of a magnetic material, and is excited when the coil assembly generates the magnetic force. The movable core is made of a magnetic material, and is moved to the stator core when the coil assembly generates the magnetic force. The guide portion slidably receives the movable core and is filled with the high-pressure fluid. The guide portion includes a magnetism blocking portion that blocks a magnetic flux over a whole periphery of a predetermined position in an axial direction of the guide portion, and a magnetism passing portion through which the magnetic flux passes. The ring portion is made of a magnetic material and is provided at a periphery of the guide portion. The ring portion abuts on a first end part of the coil assembly. The cover portion is connected with the guide portion or the stator core. The cover portion abuts on a second end part of the coil assembly to bias the coil assembly towards the ring portion. The valve member is connected with the stator core. The seat member forms a valve seat abutting on or separating from the valve member to block or allow the flow of the high-pressure fluid. Further, when the coil assembly generates the magnetic force, an expansion magnetic circuit bypassing the magnetism blocking portion is generated between the magnetism passing portion of the guide portion and the movable core.

In the electromagnetic valve device for the high-pressure fluid, the movable core is moved to the stator core by the magnetic circuit generated by energizing the coil assembly. In this case, the magnetic circuit is generated between an end surface of the stator core close to the movable core and an end surface of the movable core close to the stator core, and between the magnetism passing portion of the guide portion and the end surface of the movable core close to the stator core. The magnetic circuit between the magnetism passing portion and the movable core is generated relatively readily for the magnetic flux to pass through, and is generated to incline with respect to a center axis of the guide portion by bypassing the magnetism blocking portion which is readily magnetically saturated because the magnetic flux relatively difficultly passes through. The magnetic circuit generates an electromagnetic attractive force to move the movable core to the stator core.

Since the ring portion made of a magnetic material abuts on the first end part of the coil assembly, one magnetic circuit passing through the coil assembly, the guide portion, and the movable core, and another magnetic circuit passing through the coil assembly, the guide portion, the ring portion, and the movable core, are generated. These two magnetic circuits are referred to as the expansion magnetic circuit.

The movable core is moved to the stator core not only by a magnetic attractive force generated by the expansion magnetic circuit between the end surface of the stator core close to the movable core and the end surface of the movable core close to the stator core, but also a magnetic attractive force generated by the expansion magnetic circuit between the magnetism passing portion of the guide portion and the end surface of the movable core close to the stator core.

Therefore, a facing area of the movable core relative to the stator core can be made smaller than that of when the movable core is moved only by the magnetic attractive force generated by the magnetic circuit between the stator core and the movable core. Further, the facing area of the movable core can be made smaller than that of when the movable core is moved only by the magnetic attractive force generated by the magnetic circuit without passing the ring portion. Thus, a diameter of the movable core can be made smaller, and the size of the electromagnetic valve device for the gaseous fuel can be made smaller.

Further, since the diameter of the movable core of the electromagnetic valve device for the high-pressure fluid becomes smaller, a diameter of the guide portion slidably receiving the movable core becomes smaller. When the diameter of the guide portion is decreased, a pressure resistance of the guide portion repelling a pressure of the gaseous fuel filled in the guide portion is improved. Therefore, when the guide portion is filled with the high-pressure fluid of the same pressure, a thickness of the guide portion can be made thinner than that of when the movable core is moved only by the magnetic attractive force generated by the magnetic circuit between the stator core and the movable core with out passing the ring portion. Thus, the size of the electromagnetic valve device for the gaseous fuel can be made further smaller.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing an outline of a gaseous fuel supplying system to which an electromagnetic valve device for a gaseous fuel is applied, according to a first embodiment of the present disclosure;

FIG. 2 is a sectional view showing the electromagnetic valve device for the gaseous fuel, according to the first embodiment;

FIG. 3 is a sectional view showing the electromagnetic valve device for the gaseous fuel in a different operation from FIG. 2, according to the first embodiment;

FIG. 4 is a sectional view showing the electromagnetic valve device for the gaseous fuel in a different operation from FIGS. 2 and 3, according to the first embodiment; and

FIG. 5 is a sectional view showing the electromagnetic valve device for the gaseous fuel, according to a second embodiment of the present disclosure.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, embodiments of the present disclosure will be described with reference to drawings.

### First Embodiment

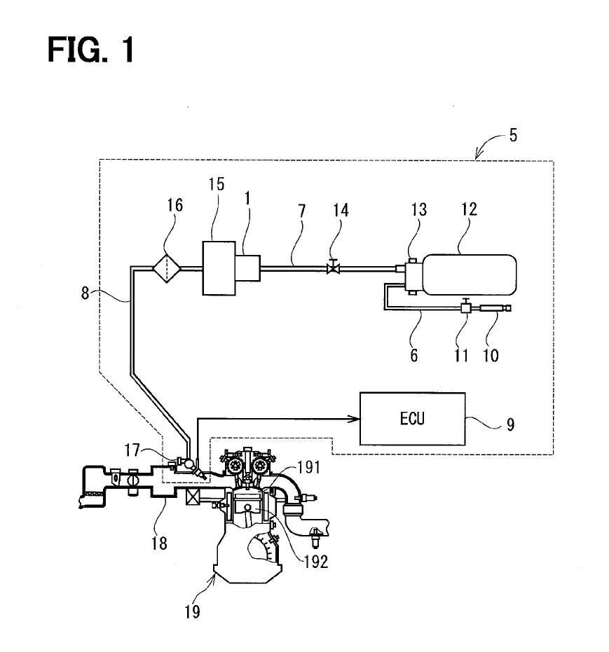

Referring to FIGS. 1 to 4, an electromagnetic valve device 1 for a gaseous fuel according to a first embodiment of the present disclosure will be detailed.

First, a gaseous fuel supplying system to which the electromagnetic valve device 1 is applied will be described with reference to FIG. 1. The gaseous fuel supplying system 5, for example, is mounted to a vehicle using a compressed natural gas as fuel. The gaseous fuel supplying system 5 includes a gas inlet 10, a fuel tank 12, the electromagnetic valve device 1, a pressure control valve 15 for the gaseous fuel, an injector 17 for the gaseous fuel, and an electrical control unit 9. According to the present disclosure, the injector 17 corresponds to an injection portion.

The gaseous fuel of high-pressure is supplied from external to the gas inlet 10, and is introduced into and stored in the fuel tank 12 via a supply pipe 6. The gas inlet 10 has a back-flow preventing function to control the gaseous fuel so that the gaseous fuel supplied from the gas inlet 10 does not backflow to external. The supply pipe 6 is provided with a gas filling valve 11.

The fuel tank 12 is provided with a fuel tank valve 13. The fuel tank valve 13 has a back-flow prevention function, an excess flow prevention function, and a pressurization prevention function. The back-flow prevention function of the fuel tank valve 13 is for preventing the gaseous fuel from back-flowing from the fuel tank 12 to the gas inlet 10. The excess flow prevention function is for blocking a flow of the gaseous fuel from the fuel tank 12 in a case where a flow amount of the gaseous fuel flowing through a supply tube 7 is greater than or equal to a predetermined amount. The pressurization prevention security function is for preventing a damage of the fuel tank 12 by opening the fuel tank 12 to external in a case where a pressure in the fuel tank 12 is increased.

The fuel tank valve 13 is connected with the electromagnetic valve device 1 via the supply tube 7. The supply tube 7 is provided with a master valve 14 capable of manually blocking the supply tube 7.

The electromagnetic valve device 1 is placed at a position upstream of the pressure control valve 15. That is, the electromagnetic valve device 1 is positioned between the pressure control valve 15 and the fuel tank 12. When a pressure of the gaseous fuel flowing downstream of the pressure control valve 15 is greater than or equal to a predetermined pressure, the electromagnetic valve device 1 blocks the flow of the gaseous fuel introduced into the pressure control valve 15 according to a command of the ECU 9. The electromagnetic valve device 1 for the gaseous fuel blocks or allows a flow of the gaseous fuel by an electromagnetic valve which is not shown.

The pressure control valve 15 depressurizes the pressure of the gaseous fuel supplied from the supply tube 7 to a pressure so that the injector 17 is capable of injecting the gaseous fuel. For example, the pressure control valve 15 depressurizes a high-pressure of the gaseous fuel in the fuel tank 12 to a low-pressure so that the injector 17 is capable of injecting the gaseous fuel. In this case, the high-pressure is 20 MPa, and the low-pressure is within a pressure range from 0.2 MPa to 0.65 MPa.

In the gaseous fuel depressurized by the pressure control valve 15, oil is removed by an oil filter 16. Then, the gaseous fuel is supplied to the injector 17 via a supply duct 8. The injector 17 injects the gaseous fuel into an intake pipe 18 according to an indication of the ECU 9 which is electrically connected with the injector 17. The injector 17 is provided with a temperature sensor and a pressure sensor which are not shown. A temperature of the gaseous fuel and the pressure of the gaseous fuel which are detected by the temperature sensor and the pressure sensor, respectively, are outputted to the ECU 9.

The gaseous fuel injected into the intake pipe 18 is mixed with an air introduced from the atmosphere. Then, a mixed gas is introduced into a cylinder 191 from an intake port of an engine 19. In this case, the mixed gas is the gaseous fuel mixed with the air, and the engine 19 is connected with the intake pipe 18 and is used as an internal combustion engine. In the engine 19, a rotational torque is generated by a compression and a combustion of the mixed gas according to a lifting of a piston 192. The mixed gas is the gaseous fuel mixed with the air.

The gaseous fuel supplying system 5 depressurizes the pressure of the gaseous fuel in the fuel tank 12 to the pressure so that the injector 17 is capable of injecting the gaseous fuel, and supplies the gaseous fuel to the engine 19 by the injector 17.

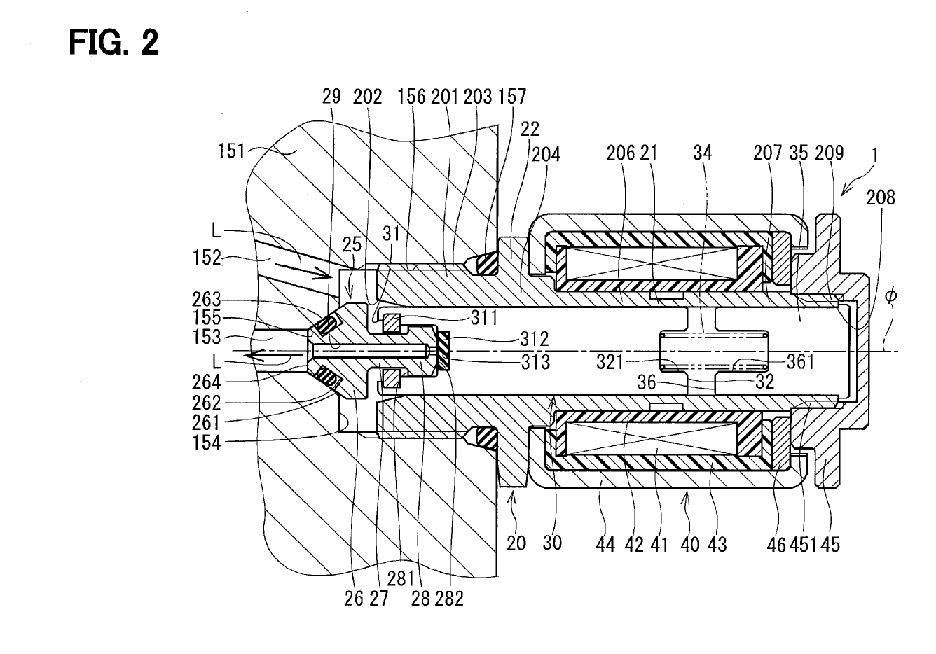

Next, a configuration of the electromagnetic valve device 1 according to the first embodiment will be described with reference to FIGS. 2 to 4. Further, solid arrows L shown in FIGS. 2 to 4 indicate flow directions of the gaseous fuel.

According to the first embodiment, the electromagnetic valve device 1 is constructed by a support member 151, a valve seat 155, a guide portion 20, a ring portion 22, a valve member 25, a movable core 30, a stator core 35, a coil assembly 40 and a cover portion 45.

The support member 151 includes an inlet passage 152, an outlet passage 153, and a concave portion 154. The concave portion 154 communicates with the inlet passage 152 and the outlet passage 153. The gaseous fuel in the fuel tank 12 is supplied to the inlet passage 152 via the supply tube 7. The gaseous fuel is exhausted from the outlet passage 153 towards the pressure control valve 15. The concave portion 154 is provided so that the concave portion 154 has an opening on an outer wall of the support member 151. Further, an internal-screw groove 156 is provided in the inner wall of the concave portion 154 which is substantially perpendicular to the outer wall of the support member 151. The internal-screw groove 156 is for screwing the guide portion 20.

The valve seat 155 is a part of an inner wall of the concave portion 154 of the support member 151, and is taper-shaped so that the valve seat 155 is inclined from the concave portion 154 to the outlet passage 153. According to the present embodiment, the support member 151 forming the valve seat 155 corresponds to a seat member.

Further, in the electromagnetic valve device 1 according to the first embodiment, the support member 151 corresponds to a valve body of the pressure control valve 15 connected with a downstream end of the electromagnetic valve device 1. It is not limited to the above configuration. For example, the support member 151 may be provided as another part different from the valve body of the pressure control valve 15.

The guide portion 20 is supported by the support member 151. The guide portion 20 slidably receives the movable core 30 in an axial direction of the guide portion 20. The guide portion 20 is provided to be filled with and not to leak the gaseous fuel of high-pressure from the inlet passage 152 to the outlet passage 153 via the concave portion 154.

The guide portion 20 is constructed by a large-diameter portion 201, a medium-diameter portion 204, a first small-diameter portion 206, a magnetism blocking portion 21, and a second small-diameter portion 207, from the support member 151. The large-diameter portion 201, the medium-diameter portion 204, the first small-diameter portion 206, the magnetism blocking portion 21, and the second small-diameter portion 207 are integrally bonded to each other. The guide portion 20 is made of a magnetic material, such as a magnetic stainless steel including chromium from 13 wt % to 17 wt %

The large-diameter portion 201 is substantially tube-shaped and has a first outer diameter and an inner diameter which are predetermined. A first end part of the large-diameter portion 201 has an opening 202 and an external-screw groove 203. The movable core 30 or the valve member 25 slides into or out of the guide portion 20, through the opening 202. The external-screw groove 203 is screwed with the internal-screw groove 156 of the support member 151.

The medium-diameter portion 204 is substantially tube-shaped, and has a second outer diameter less than the first outer diameter of the large-diameter portion 201, and an inner diameter equal to the inner diameter of the large-diameter portion 201. A first end part of the medium-diameter portion 204 is connected with a second end part of the large-diameter portion 201.

The first small-diameter portion 206 is substantially tube-shaped, has a third outer diameter less than the second outer diameter of the medium-diameter portion 204, and has an inner diameter equal to the inner diameter of the medium-diameter portion 204. A first end part of the first small-diameter portion 206 is connected with a second end part of the medium-diameter portion 204. According to the present embodiment, the first small-diameter portion 206 corresponds to a magnetism passing portion.

The magnetism blocking portion 21 is substantially tube-shaped, has a fourth outer diameter less than the third outer diameter of the first small-diameter portion 206, and has an inner diameter equal to the inner diameter of the first small-diameter portion 206. A first end part of the magnetism blocking portion 21 is connected with a second end part of the first small-diameter portion 206.

The second small-diameter portion 207 is substantially tube-shaped, has a third outer diameter equal to the third outer diameter of the first small-diameter portion 206, and has an inner diameter equal to the inner diameter of the magnetism blocking portion 21. A first end part of the second small-diameter portion 207 is connected with a second end part of the magnetism blocking portion 21.

The magnetism blocking portion 21 between the first small-diameter portion 206 and the second small-diameter portion 207 has the inner diameter equal to the inner diameter of the first small-diameter portion 206 and the inner diameter of the second small-diameter portion 207, and has the fourth outer diameter less than the third outer diameter of the first small-diameter portion 206 and the third outer diameter of the second small-diameter portion 207. In other words, the magnetism blocking portion 21 has a wall thickness less than that of the first small-diameter portion 206 and the second small-diameter portion 207. In the electromagnetic valve device 1 of the gaseous fuel according to the first embodiment, for example, the wall thickness of the magnetism blocking portion 21 is from 0.6 mm to 0.9 mm. Therefore, it is difficult for a magnetic flux generated by energizing a coil 41 to pass through the magnetism blocking portion 21, and the magnetism blocking portion 21 is readily magnetically saturated.

A second end part of the second small-diameter portion 207 is provided with a port 208 and an external-thread groove 209. The port 208 is a member for fixing the stator core 35. The external-thread groove 209 is provided radially outside of the second small-diameter portion 207. The external-thread groove 209 is a member for screwing the cover portion 45. According to the present embodiment, the second small-diameter portion 207 corresponds to the magnetism passing portion.

The ring portion 22 is provided radially outside of the medium-diameter portion 204 of the guide portion 20, and has an outer diameter greater than the first outer diameter of the large-diameter portion 201. In other words, the ring portion 22 is provided at a periphery of the guide portion 20. The ring portion 22 is made of a magnetic material, such as a magnetic stainless steel including chromium from 13 wt % to 17 wt %. The ring portion 22 and the guide portion 20 are integrally bonded to each other. When the guide portion 20 is attached to the support member 151, or when the guide portion 20 is detached from the support member 151, a rotational torque is applied to the ring portion 22 by tools.

A seal member 157 is provided between a first end part of the ring portion 22 and the support member 151 so as to prevent the gaseous fuel from being leaked from the concave portion 154. A second end part of the ring portion 22 abuts on the coil assembly 40. In other words, the ring portion 22 has a function to support a first end part of the coil assembly 40.

The valve member 25 is constructed by a contact portion 26, a small-radius portion 27, and a large-radius portion 28. The contact portion 26, the small-radius portion 27 and the large-radius portion 28 which are made of a non-magnetic material are integrally bonded to each other. The valve member 25 is abutting on or separating from the valve seat 155, according to a sliding movement of the movable core 30.

The contact portion 26 which is a truncated-cone shape has an incline surface 261 capable of abutting on or separating from the valve seat 155. The incline surface 261 has a receiving chamber 262. The receiving chamber 262 which is ring-shaped has a concave shape in a sectional view. The receiving chamber 262 receives a seal portion 263. When the incline surface 261 abuts on the valve seat 155, the seal portion 263 holds an airtight state between the concave portion 154 and the outlet passage 153.

The small-radius portion 27 has a first end part connected with a first end part of the contact portion 26 opposite to the incline surface 261. The small-radius portion 27 has an outer diameter which is less than the maximum diameter of the contact portion 26 and an outer diameter of the large-radius portion 28.

The large-radius portion 28 has a first end part which is connected with a second end part of the small-radius portion 27 opposite to the first end part of the small-radius portion 27 connected with the contact portion 26. A step surface 281 is provided at the first end part of the large-radius portion 28 connected with the small-radius portion 27. A tip surface 282 capable of abutting on a seal element 312 is provided at a second end part of the large-radius portion 28 opposite to the step surface 281.

The valve member 25 is further provided with a through hole 29 penetrating the contact portion 26, the small-radius portion 27 and the large-radius portion 28 in an axial direction of the valve member 25. Openings of the through hole 29 are defined by both an edge surface 264 positioned at a second end part of the contact portion 26 opposite to the first end part of the contact portion 26 connected with the small-radius portion 27 and the tip surface 282 of the large-radius portion 28.

The movable core 30 is a member slidably received in the guide portion 20, and is made of a magnetic material such as a magnetic stainless steel.

When the movable core 30 slides in the guide portion 20 in the axial direction of the movable core 30, an outer peripheral surface of the movable core 30 slides on an inner peripheral surface of the guide portion 20. The outer peripheral surface of the movable core 30 is provided with a plating film that is made of a non-magnetic material and has an abrasion resistance.

A concave part 31 is provided on a first end part of the movable core 30, and receives a part of the small-radius portion 27 of the valve member 25 and the large-radius portion 28 of the valve member 25. In this case, an inner side wall of the concave part 31 and an outer wall of the large-radius portion 28 of the valve member 25 define a gap.

A limit member 311 is ring-shaped and is provided on an inner wall of a tip part of the concave part 31. When the valve member 25 moves in a direction separating the valve member 25 from a bottom surface of the concave part 31 of the medium outer-diameter part 303, the limit member 311 abuts on the step surface 281 of the valve member 25. Therefore, a distance of the valve member 25 relatively moving with respect to the movable core 30 is limited. The valve member 25 is indirectly connected with the movable core 30 via the limit member 311. A receiving chamber 313 receiving the seal element 312 is provided at the bottom surface of the concave part 31.

The end surface 32 is provided on a second end part of the movable core 30, and has a depression part 321.

The stator core 35 is a rod-shaped member made of a magnetic material, and is fixed in the port 208 of the second small-diameter portion 207 of the guide portion 20. A margin surface 36 of the stator core 35 is arranged at a first end part of the stator core 35 to face the end surface 32 of the movable core 30. The margin surface 36 is provided with a recess part 361 corresponding to the depression part 321.

A spring 34 is provided between a bottom surface of the depression part 321 and a bottom surface of the recess part 361. The spring 34 generates a biasing force to separate the end surface 32 from the margin surface 36 and to bias the movable core 30 in a direction towards the valve seat 155.

The coil assembly 40 is provided to surround a part of the medium-diameter portion 204 of the guide portion 20, the first small-diameter portion 206 of the guide portion 20, the magnetism blocking portion 21 of the guide portion 20, and the second small-diameter portion 207 of the guide portion 20, in a direction radially outside of the guide portion 20. The coil assembly 40 is constructed by the coil 41, a bobbin 42, a cover 43, and a yoke 44.

The coil 41 generates a magnetic field around the coil 41 according to a current supplied via a connector.

The bobbin 42 and the cover 43 are non-magnetic members which are provided to cover the coil 41. The yoke 44 which is made of a magnetic material is provided radially outside of the bobbin 42 and the cover 43. The yoke 44 is crimped at both end parts to fasten the coil 41, the bobbin 42, and the cover 43 to the guide portion 20. The yoke 44 is provided to cover the cover 43. A first end part of the yoke 44 abuts on the ring portion 22.

The cover portion 45 which is tube-shaped is a metal member having a bottom. An internal-thread groove 451 is provided on an inner wall of the cover portion 45. The internal-thread groove 451 is screwed with the external-thread groove 209 of the second small-diameter portion 207 of the guide portion 20 so that the cover portion 45 is attached to the second small-diameter portion 207 of the guide portion 20.

A spacer 46 made of a non-magnetic material is provided between the cover portion 45 and the coil assembly 40. Therefore, a biasing force biasing the coil assembly 40 via the spacer 46 in a direction towards the ring portion 22 is generated by screwing the cover portion 45 with the guide portion 20. Thus, the coil assembly 40 is stably supported between the cover portion 45 and the ring portion 22 via the spacer 46.

Next, an operation and effects of the electromagnetic valve device 1 according to the first embodiment will be described with reference to FIGS. 2 to 4.

When the current does not flow through the coil 41 of the electromagnetic valve device 1, only the biasing force of the spring 34 is applied to the movable core 30, thereby biasing the movable core 30 in a separating direction separating the movable core 30 from the stator core 35. Further, the concave portion 154 communicates with the inlet passage 152, and the concave portion 154 is filled with the gaseous fuel of high-pressure. Then, the tip surface 282 of the valve member 25 abuts on the seal element 312, and the incline surface 261 of the valve member 25 supported by the movable core 30 abuts on the valve seat 155. Thus, the inlet passage 152 is blocked from communicating with the outlet passage 153.

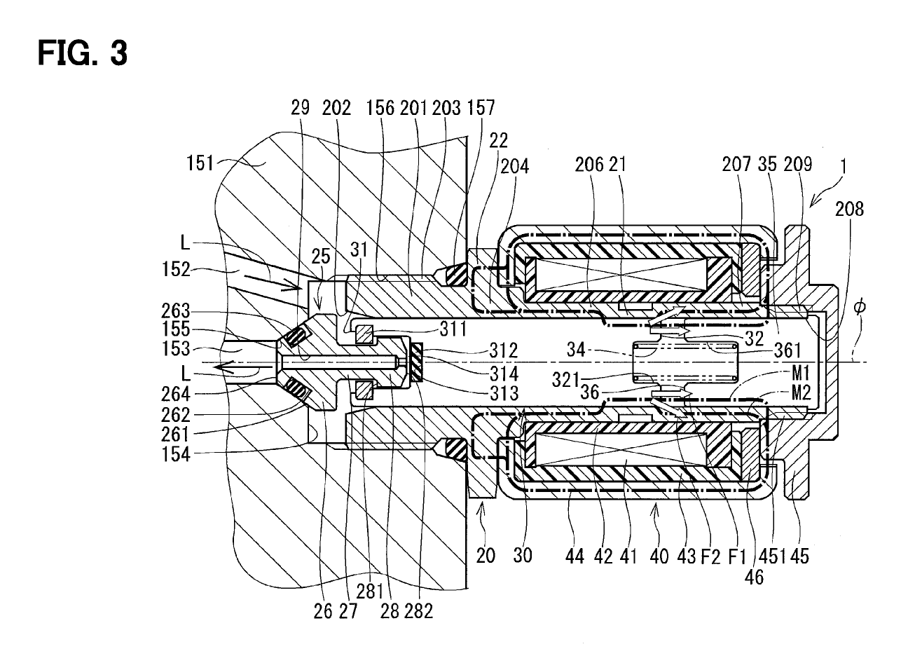

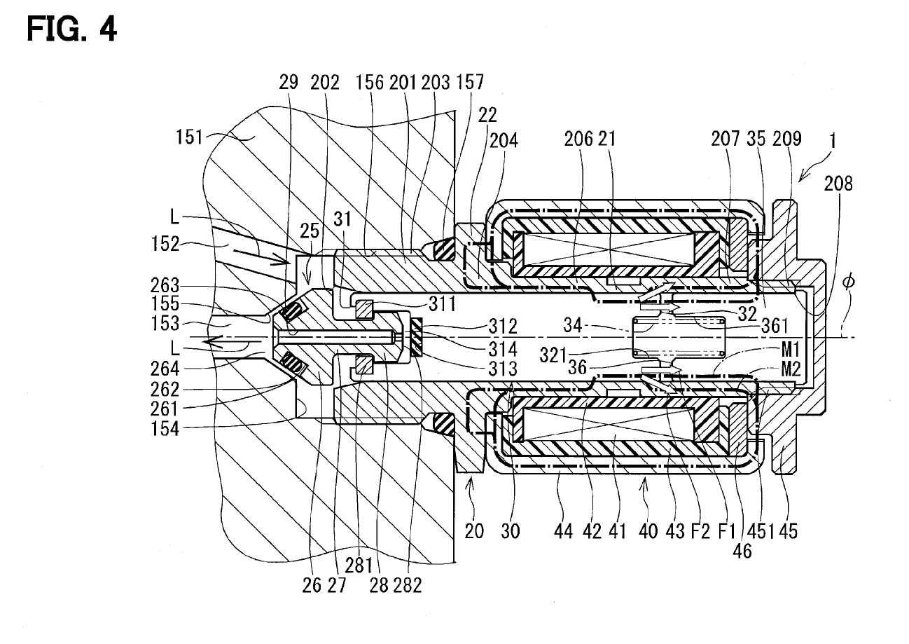

When the current flows through the coil 41, magnetic circuits are generated around the coil 41. A magnetic circuit M1 is a magnetic circuit of the magnetic circuits as dashed-dotted lines shown in FIGS. 3 and 4. The magnetic circuit M1 is generated so that a magnetic flux passes from the yoke 44 back to the yoke 44 through the medium-diameter portion 204, the first small-diameter portion 206, the movable core 30, the end surface 32, the margin surface 36, the stator core 35, the second small-diameter portion 207, and the cover portion 45. When the first magnetic circuit M1 is generated, the stator core 35 is excited.

In this case, since the ring portion 22 abuts on a first end part of the yoke 44, another magnetic circuit is generated from the yoke 44 back to the yoke 44 through the ring portion 22, the medium-diameter portion 204, the first small-diameter portion 206, the movable core 30, the end surface 32, the margin surface 36, the stator core 35, the second small-diameter portion 207, and the cover portion 45.

The magnetic circuit passing through the ring portion 22 and the magnetic circuit M1 are referred to as an expansion magnetic circuit EM1.

When the current flowing through the coil 41 is small, a magnetic circuit is generated so that the magnetic flux passes from the yoke 44 back to the yoke 44 through the first small-diameter portion 206 of the guide portion 20, the magnetism blocking portion 21, the second small-diameter portion 207 and the cover portion 45. Since the magnetism blocking portion 21 has the wall thickness thinner than that of the first small-diameter portion 206 and the second small-diameter portion 207, the magnetism blocking portion 21 is readily magnetically saturated. When the current flowing through the coil 41 is increased, the magnetic circuit becomes a magnetic circuit generated to bypass the magnetism blocking portion 21 so that the magnetic flux passes from the yoke 44 back to the yoke 44 through the first small-diameter portion 206 of the guide portion 20, the small outer-diameter part 301 of the movable core 30, the second small-diameter portion 207 of the guide portion 20 and the cover portion 45. In this case, the magnetism blocking portion 21 blocks the magnetic flux over the whole periphery of a predetermined position of the guide portion 20 in the axial direction of the movable core 30.

When the current flowing through the coil 41 is further increased, an area between the small outer-diameter part 301 and the second small-diameter portion 207 is magnetically saturated because the plating film made of a non-magnetic material is provided on the outer peripheral surface of the small outer-diameter part 301. Then, a magnetic circuit M2 is generated from the yoke 44 back to the yoke 44 through the medium-diameter portion 204, the first small-diameter portion 206, the movable core 30, the end surface 32, the second small-diameter portion 207 and the cover portion 45, as the dashed-dotted lines shown in FIGS.

In this case, since the ring portion 22 abuts on the first end part of the yoke 44, another magnetic circuit is generated from the yoke 44 back to the yoke 44 through the ring portion 22, the medium-diameter portion 204, the first small-diameter portion 206, the movable core 30, the end surface 32, the second small-diameter portion 207, and the cover portion 45.

The magnetic circuit passing through the ring portion 22 and the magnetic circuit M2 are referred to as an expansion magnetic circuit EM2.

In addition, when the ring portion 22 is not provided, or when the ring portion 22 is provided and is made of non-magtice material, or a member made of a non-magnetic material is provided between the ring portion 22 and the yoke 44, the above magnetic circuit passing through the ring portion 22 is not generated.

When the expansion magnetic circuit EM1 is generated, a magnetic attractive force F1 is generated between the movable core 30 and the stator core 35. The magnetic attractive force F1 is a magnetic attractive force in a direction parallel to a center axis φ of the guide portion 20 as shown in FIG. 3. The magnetic attractive force F1 moves the end surface 32 of the movable core 30 in a direction towards the margin surface 36 of the stator core 35. When the expansion magnetic circuit EM2 is generated, a magnetic attractive force F2 is generated between the end surface 32 of the movable core 30 and the second small-diameter portion 207 of the guide portion 20. The magnetic attractive force F2 is a magnetic attractive force inclining with respect to the center axis φ of the guide portion 20. According to the present disclosure, the first and second magnetic attractive forces F1 and F2 correspond to a magnetic force.

The magnetic attractive force F1 generated by the expansion magnetic circuit EM1 is greater than a magnetic attractive force generated by the magnetic circuit M1 of when the magnetic circuit passing through the ring portion 22 is not generated. Similarly, the magnetic attractive force F2 generated by the expansion magnetic circuit EM2 is greater than a magnetic attractive force generated by the magnetic circuit M2 of when the magnetic circuit passing through the ring portion 22 is not generated.

As the above description, when the current flows through the coil 41, the movable core 30 moves in the direction towards the stator core 35 by canceling the biasing force of the spring 34 according to the magnetic attractive forces F1 and F2. When the movable core 30 moves in the direction towards the stator core 35, the tip surface 282 of the valve member 25 separates from the seal element 312 to define a space 314, as shown in FIG. 3.

The gaseous fuel of high-pressure which has been filled in the concave portion 154 flows into the space 314 between the tip surface 282 of the valve member 25 and the seal element 312 through a gap between the limit member 311 and an outer wall of the small-radius portion 27 of the guide portion 20 and the gap between the inner wall of the concave part 31 of the movable core 30 and an outer wall of the large-radius portion 28 of the valve member 25. The gaseous fuel flowing into the space 314 flows into the outlet passage 153 via the through hole 29. Thus, a difference between the pressure of the gaseous fuel in the concave portion 154 and the pressure of the gaseous fuel in the outlet passage 153 is decreased.

Further, when the movable core 30 moves in the direction towards the stator core 35, the limit member 311 abuts on the step surface 281 of the valve member 25, as shown in FIG. 4. When the movable core 30 further moves in the direction towards the stator core 35, the valve member 25 moves together with the movable core 30 in the direction towards the stator core 35, and the incline surface 261 of the valve member 25 separates from the valve seat 155. Thus, the gaseous fuel of the concave portion 154 flows into the outlet passage 153 via a gap between the valve member 25 and the valve seat 155.

Effects of the electromagnetic valve device 1 according to the first embodiment will be summarized as followings.

(1) According to the electromagnetic valve device 1, the magnetism blocking portion 21 is provided between the first small-diameter portion 206 and the second small-diameter portion 207, and the ring portion 22 made of a magnetic material abuts on the first end part of the yoke 44. Therefore, when the coil 41 is energized, two expansion magnetic circuits EM1, EM2 are generated. The expansion magnetic circuit EM2 is a combination of the magnetic circuit M2 generated to bypass the magnetism blocking portion 21 and to pass from the yoke 44 back to the yoke 44 through the medium-diameter portion 204, the first small-diameter portion 206, the movable core 30, the end surface 32, the second small-diameter portion 207, and the cover portion 45, and the magnetic circuit generated to bypass the magnetism blocking portion 21 and to pass from the yoke 44 back to the yoke 44 through the ring portion 22, the medium-diameter portion 204, the first small-diameter portion 206, the movable core 30, the end surface 32, the second small-diameter portion 207, and the cover portion 45.

In this case, the magnetic attractive force F2 inclining with respect to the center axis φ of the guide portion 20 is generated between the second small-diameter portion 207 of the guide portion 20 and the end surface 32 of the movable core 30. The movable core 30 is moved in the direction towards the stator core 35 according to a part of the magnetic attractive force F2 parallel to the center axis φ.

That is, in the electromagnetic valve device 1, the movable core 30 is moved in the direction towards the stator core 35 by not only the magnetic attractive force F1 generated according to the magnetic circuit M1 but also the magnetic attractive force F2 generated according to the magnetic circuit M2. Therefore, as a whole, when an attractive force which is predetermined is generated, a percentage of the magnetic attractive force F1 in the attractive force becomes smaller. In other words, a facing area of the end surface 32 of the movable core 30 relative to the margin surface 36 of the stator core 35 can be made relatively smaller, and a diameter of the movable core 30 can be made smaller. Thus, a size of the electromagnetic valve device 1 can be made smaller.

(2) As the above description, since the diameter of the movable core 30 can be made smaller, the wall thickness of the guide portion 20 having a pressure resistance relative to the gaseous fuel of high-pressure filled in the guide portion 20 can be made relatively thinner.

Specifically, the pressure of the gaseous fuel in the guide portion 20 is referred to as a pressure P, and the unit of the pressure P is Pa. An inner diameter of the guide portion 20 is referred to as an inner diameter D, and the unit of the inner diameter D is m. The wall thickness of the guide portion 20 is referred to as a wall thickness T, and the unit of the wall thickness T is m. A stress σ1 represents a stress in a direction parallel to the center axis φ, and the unit of the stress σ1 is N. A stress σ2 represents a stress in a radial direction, and the unit of the stress σ2 is N. The relationship between the above parameters is indicated as following formulas.

σ1=(P*D)/(4*T) (i)

σ2=(P*D)/(2*T) (ii)

According to formulas (i) and (ii), when the inner diameter D is increased, the stress σ1 in the direction parallel to the center axis φ and the stress σ2 in the radial direction are increased. Then, it is necessary to increase the wall thickness T. In the electromagnetic valve device 1 according to the first embodiment, the inner diameter is relatively smaller, so the stress σ1 and the stress σ2 are decreased. Thus, the wall thickness T can be made smaller. Therefore, the size of the electromagnetic valve device 1 can be made further smaller.

(3) The outer peripheral surface of the movable core 30 slidable on the inner peripheral surface of the guide portion 20 is provided with the plating film having a high abrasion resistance. Thus, a deformation due to abrasion in a case where the movable core 30 slides can be prevented.

(4) The outer peripheral surface of the movable core 30 slidable on the inner peripheral surface of the guide portion 20 is provided with the plating film made of a non-magnetic material. Thus, when the magnetic circuit is generated between the guide portion 20 and the movable core 30, a magnetic attractive force generated in a direction perpendicular to the center axis φ of the guide portion 20 becomes extremely smaller. In this case, the magnetic attractive force is one of magnetic attractive forces generated between the inner peripheral surface of the guide portion 20 and the outer peripheral surface of the movable core 30.

Further, an eccentricity rate of the movable core 30 due to the magnetic attractive force relative to the guide portion 20 becomes smaller. In this case, the magnetic attractive force is generated in the direction perpendicular to the center axis φ of the guide portion 20. Furthermore, a frictional resistance of when the movable core 30 slides becomes smaller. Therefore, the valve member 25 can be opened at a small attractive force, and the performance at the low voltage is improved. Thus, the coil assembly 40 can be made smaller, and the size of the electromagnetic valve device 1 can be made further smaller.

(5) The spring 34 provided between the bottom surface of the depression part 321 of the movable core 30 and the bottom surface of the recess part 361 of the stator core 35 separates the end surface 32 of the movable core 30 from the margin surface 36 of the stator core 35 and biases the movable core 30 in the direction towards the valve seat 155. Thus, when the magnetic attractive forces F1 and F2 become zero because the current flowing through the coil 41 becomes zero, the movable core 30 is rapidly moved in a direction towards the valve seat 155, and the valve member 25 abuts on the valve seat 155. Thus, a closing motion of the electromagnetic valve device 1 can be rapidly executed.

### Second Embodiment

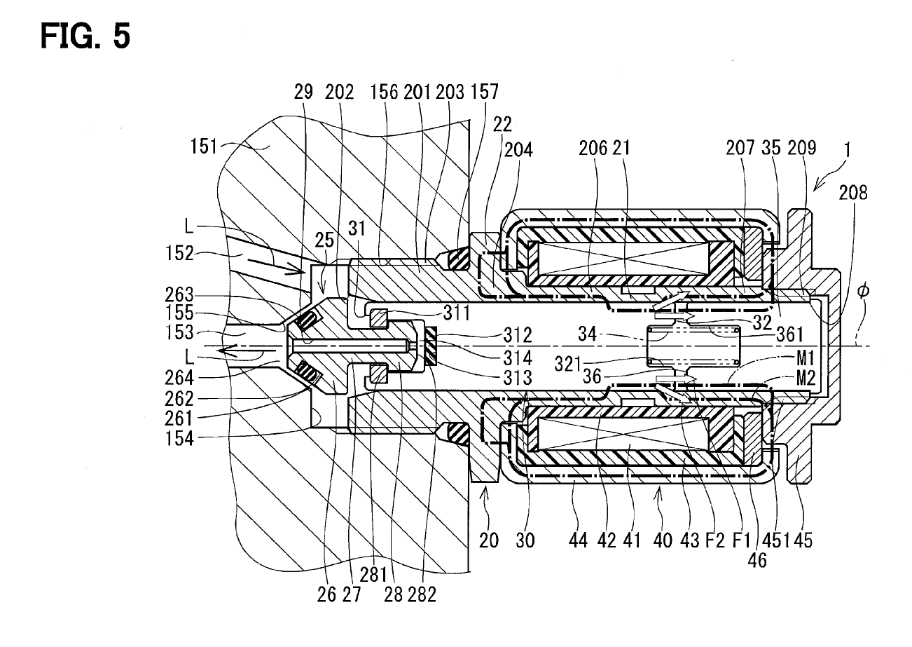

Next, an electromagnetic valve device for the gaseous fuel according to a second embodiment of the present disclosure will be described with reference to FIG. 5. The second embodiment has features different from the first embodiment. Specifically, in the second embodiment, an elastic member is provided. The substantially same parts and the components as the first embodiment are indicated with the same reference numeral and the same description will not be reiterated.

According to the first embodiment, the coil assembly 40 has a first end part abutting on the ring portion 22, and a second end part in contact with the cover portion 45 via the spacer 46. The coil assembly 40 is stably supported between the cover portion 45 and the ring portion 22 according to the biasing force generated by screwing the cover portion 45 with the guide portion 20.

In contrast, according to the second embodiment, as shown in FIG. 5, for example, an elastic member 441 made of a rubber member or a washer is provided between a second end part of the yoke 44 of the coil assembly 40 and the cover portion 45.

Since the elastic member 441 is provided between the second end part of the yoke 44 of the coil assembly 40 and the cover portion 45, even though a deterioration of erosion is generated due to a long time period, a looseness of screwing the cover portion 45 with the guide portion 20 is prevented, and the biasing force relative to the coil assembly 40 is stably held by a screwing of the cover portion 45.

Therefore, the coil assembly 40 between the cover portion 45 and the ring portion 22 is stably held over a long time period.

Further, since the elastic member 441 is provided between the second end part of the yoke 44 of the coil assembly 40 and the cover portion 45, when the cover portion 45 is screwed with the guide portion 20, a torque adjustment is readily conducted. Therefore, when the cover portion 45 is screwed with the guide portion 20, a damage of the magnetism blocking portion 21 having a relatively thin wall thickness is prevented even though a stress applied to the guide portion 20 becomes excessive due to an excessive torque applied to the cover portion 45.

As the above description, the electromagnetic valve device 2 according to the second embodiment can accomplish effects (1) to (5) in the first embodiment. Further, the coil assembly 40 between the cover portion 45 and the ring portion 22 is stably held over a long time period, and the damage of the magnetism blocking portion 21 caused due to an excessive torque applied to the cover portion 45 in a case where the cover portion 45 is screwed with the guide portion 20 can be prevented.

### Other Embodiment

(a) According to the above embodiments, the electromagnetic valve device for the gaseous fuel is applied to a gaseous fuel supply system in which the gaseous fuel is supplied to the engine, and blocks or allows the flow of the gaseous fuel. However, the electromagnetic valve device for the gaseous fuel of the present disclosure is not limited to the above system. The electromagnetic valve device for the gaseous fuel may be an electromagnetic valve device that blocks or allows a flow of a high-pressure fluid filled in a guide portion.

(b) According to the above embodiments, the electromagnetic valve device for the gaseous fuel in which the through hole is provided in the valve member is used as a pilot valve to communicate with the inlet passage and the outlet passage via the through hole before the incline surface of the valve member separates from a seat surface. However, the electromagnetic valve device for the gaseous fuel is not limited to the above configuration.

(c) According to the above embodiments, the magnetism blocking portion of the movable core is made of a magnetic stainless steel as the same as the first small-diameter portion and the second small-diameter portion. Further, the magnetism blocking portion is provided to have the wall thickness thinner than that of the first small-diameter portion and the second small-diameter portion. However, the magnetism blocking portion may be made of a non-magnetic material modified by a reformulation operation from a magnetic stainless steel including chromium. In this case, it is difficult for a magnetic flux generated by energizing a coil to pass through the magnetism blocking portion, and the magnetism blocking portion is readily magnetically saturated.

Further, the magnetism blocking portion of the movable core may combine a wall-thickness feature and a non-magnetic feature. For example, the magnetism blocking portion is provided to be made of non-magnetic and to have the wall thickness less than that of the first small-diameter portion and the second small-diameter portion.

(d) According to the above embodiments, the magnetism blocking portion has the wall thickness from 0.6 mm to 0.9 mm. However, the wall thickness of the magnetism blocking portion is not limited. The wall thickness of the magnetism blocking portion may be any values as long as the wall thickness is less than that of the first small-diameter portion and the second small-diameter portion.

(e) According to the above embodiments, the ring portion is integrally bonded to the guide portion. However, the ring portion may be another member different from the guide portion and is provided radially outside of the guide portion.

(f) According to the above embodiments, the outer peripheral surface of the movable core slidable on the inner peripheral surface of the guide portion is provided with the plating film made of a non-magnetic material. Further, the magnetic plating film which is made of a magnetic material and has the high abrasion resistance may also be used. Further, the plating film itself can be canceled.

(g) According to the above embodiments, the external-thread groove is provided radially outside of the second small-diameter portion of the guide portion. The biasing force biasing the coil assembly in a direction towards the ring portion is generated by screwing the internal-thread groove provided in the inner wall of the cover portion with the external-thread groove. However, the external-thread groove may be provided radially outside of the stator core. In this case, the external-thread groove of the stator core is screwed with the internal-thread groove of the cover portion.

Also, the biasing force biasing the coil assembly in the direction towards the ring portion is generated.

(h) According to the above embodiments, the guide portion, the ring portion, and the movable core are made of a magnetic stainless steel including chromium. However, material to form the movable core and the guide portion is not limited. The guide portion and the movable core may be made of a magnetic material.

(i) According to the above embodiments, the guide portion and the ring portion have chromium from 13 wt % to 17 wt %. However, a chromium content of the guide portion or the ring portion is not limited.

The present disclosure is not limited to the embodiments mentioned above, and can be applied to various embodiments within the spirit and scope of the present disclosure.

What is claimed is:

1. An electromagnetic valve device for a high-pressure fluid, the electromagnetic valve device comprising:
a coil assembly generating a magnetic force when being energized;
a stator core which is made of a magnetic material, and is excited when the coil assembly generates the magnetic force;
a movable core which is made of a magnetic material, and is moved to the stator core when the coil assembly generates the magnetic force;
a guide portion slidably receiving the movable core and being filled with the high-pressure fluid, the guide portion including
a magnetism blocking portion that blocks a magnetic flux over a whole periphery of a predetermined position in an axial direction of the guide portion, and
a magnetism passing portion through which the magnetic flux passes;
a ring portion which is made of a magnetic material and is provided at a periphery of the guide portion, and abuts on a first end part of the coil assembly;
a cover portion which is connected with the guide portion or the stator core, and abuts on a second end part of the coil assembly to bias the coil assembly towards the ring portion;
a valve member connected with the stator core; and
a seat member forming a valve seat abutting on or separating from the valve member to block or allow the flow of the high-pressure fluid, wherein
an expansion magnetic circuit bypassing the magnetism blocking portion is generated between the magnetism passing portion of the guide portion and the movable core, when the coil assembly generates the magnetic force.

2. The electromagnetic valve device for a high-pressure fluid, according to claim 1, wherein
the ring portion is integrally bonded to the guide portion.

3. The electromagnetic valve device for a high-pressure fluid, according to claim 1, wherein
the cover portion is screwed with the guide portion or the stator core.

4. The electromagnetic valve device for a high-pressure fluid, according to claim 1, further comprising
an elastic member provided between the cover portion and the coil assembly.
